(19) United States
(12) Patent Application Publication
(10) Pub. No.: US 2017/0264204 A1
(43) Pub. Date: Sep. 14, 2017

(54) POWER SUPPLY APPARATUS

(71) Applicant: ROHM CO., LTD., Ukyo-Ku (JP)

(72) Inventor: Kenichi MOTOKI, Ukyo-ku (JP)

(21) Appl. No.: 15/455,538

(22) Filed: Mar. 10, 2017

(30) Foreign Application Priority Data
Mar. 11, 2016 (JP) 2016-048252

(51) Int. Cl. H02M 3/335; H02M 1/08; H02M 1/32

(52) U.S. Cl. CPC H02M 3/33523; H02M 1/32; H02M 1/08; H02M 2001/0009

(57) ABSTRACT

A power supply apparatus supplies a bus voltage V_{BUS} to a power receiving apparatus via a cable. A power supply circuit generates the bus voltage VBUS. The bus switch SW is arranged on a path of a bus line extending from the output of the power supply circuit. A power supply side controller is capable of communicating with a power receiving side controller of the power receiving apparatus. The power supply side controller determines the voltage to be supplied, based on a negotiation result. Furthermore, the power supply side controller controls the bus switch SW. When a predetermined state repeatedly occurs in the power supply circuit, a short circuit detection circuit judges that a short-circuit abnormality has occurred.

### CROSS-REFERENCE TO RELATED APPLICATIONS

This application is based upon and claims the benefit of priority from the prior Japanese Patent Application No. 2016-048252, filed Mar. 11, 2016, the entire contents of which are incorporated herein by reference.

### BACKGROUND OF THE INVENTION

1. Field of the Invention

The present invention relates to a power supply technique for an electronic device.

2. Description of the Related Art

Battery-driven devices such as cellular phone terminals, smartphones, tablet terminals, laptop computers, and portable audio players each include a rechargeable secondary battery and a charger circuit that charges the secondary battery as built-in components. Known examples of such charger circuits include an arrangement that charges a secondary battery using a DC voltage (bus voltage V_{BUS}) supplied from an external circuit via a USB cable or otherwise a DC voltage from an external AC adapter.

At present, as a charger circuit mounted on a mobile device, charger circuits that is compatible with a specification which is referred to as the “USB Battery Charging Specification” (which will be referred to as the “BC specification” hereafter) have become mainstream. There are several kinds of USB hosts or USB chargers (which will collectively be referred to as a “USB power supply apparatus” hereafter). As the kinds of USB power supply apparatuses that is compatible with revision 1.2 of the BC specification, SDP (Standard Downstream Port), DCP (Dedicated Charging Port), and CDP (Charging Downstream Port) have been defined. The current (current capacity) that can be provided by a USB power supply apparatus is defined according to the kind of USB power supply apparatus. Specifically, DCP and CDP are defined to provide a current capacity of 1500 mA. Also, SDP is defined to provide a current capacity of 100 mA, 500 mA, or 900 mA, according to the USB version.

As a next-generation secondary battery charging method or system using USB, a specification which is referred to as the “USB Power Delivery Specification” (which will be referred to as the “USB-PD specification” hereafter) has been developed. The USB-PD specification allows the available power to be dramatically increased up to a maximum of 100 W, as compared with the BC standard, which provides a power capacity of 7.5 W. Specifically, the USB-PD specification allows a USB bus voltage that is higher than 5 V (specifically, 9 V, 12V, 15V, 20 V, etc.). Furthermore, the USB-PD specification allows a charging current that is greater than that defined by the BC specification (specifically, the PD specification allows a charging current of 2 A, 3 A, 5 A, etc.). The USB-PD specification is employed in the USB Type-C specification.

FIG. 1 is a block diagram showing a power supply system 100R investigated by the present inventor. The power supply system 100R conforms to the USB Type-C specification, and includes a power supply apparatus 200R and a power receiving apparatus 300R coupled via a USB cable 106. For example, the power supply apparatus 200R is mounted on an AC adapter 102, or otherwise, is mounted on an electronic device. The power receiving apparatus 300R is mounted on a battery-driven electronic device 400 such as a smartphone, tablet terminal, digital still camera, digital video camera, portable audio player, or the like.

The power supply apparatus 200R includes a power supply circuit 202, a power supply side PD controller (which will be referred to as the “power supply side controller” hereafter) 204, and a bus switch SW1. The USB cable 106 is detachably coupled to a receptacle 108 provided to the electronic device 400. It should be noted that such a receptacle 108 may be omitted. That is to say, charger adapters are known having a configuration in which the USB cable 106 and the AC adapter 102 are monolithically integrated.

The receptacle 108 includes a V_{BUS} terminal configured to supply a bus voltage V_{BUS}, a GND terminal configured to supply a ground voltage V_{GND}, and a CC (Configuration Channel) terminal. With such a receptacle-type terminal, two CC terminals are provided. However, description will be made in the present embodiment regarding an arrangement including only a single CC terminal for simplicity. The power supply circuit 202 generates the bus voltage V_{BUS}. The power supply circuit 202 may include an AC/DC converter that receives an AC voltage of 100 V from an unshown external power supply (e.g., a commercially available AC power supply), and that converts the AC voltage thus received into the bus voltage V_{BUS} in the form of a DC voltage. The bus voltage V_{BUS} generated by the power supply circuit 202 is supplied to the power receiving apparatus 300R via a bus line of the USB cable 106 and the bus switch SW1.

The power supply side controller 204 and a power receiving side controller 310 are each configured as a port controller that is compatible with the USB Type-C specification. The power supply side controller 204 and the power receiving side controller 310 are coupled via a CC line, which provides a communication function between them. Negotiation is performed between the power supply side controller 204 and the power receiving side controller 310 with respect to the voltage level of the bus voltage V_{BUS} to be supplied from the power supply apparatus 200R. The power supply side controller 204 controls the power supply circuit 202 so as to supply electric power with the voltage level thus determined, and controls on/off operations of the bus switch SW1.

The electronic device 400 includes a load (system) 402 in addition to the power supply apparatus 300R. Examples of such a load 402 include CPUs, memory, liquid crystal displays, audio circuits, and the like. The AC adapter 102 is detachably coupled to the receptacle 404 via the USB cable 106.

The power supply apparatus 300R includes a battery 302, a charger circuit 304, the power receiving side controller 310, and a bus switch SW2.

The battery 302 is configured as a rechargeable secondary battery. The charger circuit 304 receives the bus voltage V_{BUS} (which will also be referred to as the “adapter voltage V_{ADP}” on the power receiving apparatus 300R side) from the power supply apparatus 200R via the USB cable 106 and the bus switch SW2, so as to charge the battery 302. The charger circuit 304 is configured as a step-down DC/DC converter, a linear regulator, or a combination of such components.

A system voltage V_{SYS} is supplied from the charger circuit 304 to the load 402 according to at least one of the adapter voltage V_{ADP} and the voltage V_{BAT} supplied from the battery 302. Examples of such a load 402 include power management ICs (Integrated Circuits), multi-channel power supplies each including a DC/DC converter, linear regulator or the like, microcomputers, liquid crystal displays, display drivers, and so forth.

The power receiving side controller 310 is coupled such that it operates using the adapter voltage V_{ADP} as a power supply voltage. Accordingly, after the bus switch SW1 is turned on, the power receiving side controller 310 is able to operate. The power receiving side controller 310 holds data (request PDO: Power Data Object) that defines the maximum current and the bus voltage V_{BUS} to be requested by the power receiving apparatus 300R. After the AC adapter 102 and the electronic device 400 are coupled, negotiation is performed between the power supply side controller 204 and the power receiving side controller 310. As a result, the voltage level of the bus voltage V_{BUS} is determined based on the request PDO. Furthermore, the power receiving side controller 310 controls the on/off operations of the bus switch SW2.

FIG. 2 is an operation sequence diagram showing the operation of the power supply system 100 shown in FIG. 1. After the power supply apparatus 200R and the power receiving apparatus 300R are coupled via the USB cable 106, the power supply side controller 204 detects this coupling based on the state of the CC terminal (S100). Subsequently, the bus switch SW1 is turned on (S102). In this state, the power supply system 100 supplies the bus voltage V_{BUS} of 5 V, which is a default value. After the bus switch SW1 is turned on, the power supply side controller 310 enters the operable state.

Next, negotiation is performed between the power supply side controller 204 and the power receiving side controller 310, and the bus voltage V_{BUS} is determined based on the requested voltage (S104). The power supply side controller 204 switches the bus voltage V_{BUS} to the requested voltage from the initial voltage of 5 V. (S106).

After completing the switching of the bus voltage V_{BUS} to the requested voltage, the power supply side controller 204 transmits a notice thereof to the power receiving side controller 310 (S108). The power receiving side controller 310 turns on the bus switch SW2 in response to the notice thus received (5110). As a result, the bus voltage V_{BUS} is supplied to the charger circuit 304 and the load 402.

If a short circuit occurs in the power supply system 100R, this leads to heat generation. Also, in some cases, this leads to degradation in the reliability of circuit elements due to overcurrent. Thus, it is important to provide a short circuit protection technique. As a result of investigating such short circuit protection to be employed in the power supply system 100R shown in FIG. 1, the present inventor has come to recognize the following problem.

Typically, the power supply circuit 202 has a short circuit protection (SCP) function for its output terminal. With the power supply system 100R shown in FIG. 1, the power supply circuit 202 provides an SCP function which allows the power supply system 100R to detect and protect against a short-circuit abnormality that can occur between the output of the power supply circuit 202 and the bus switch SW1 as indicated by (i) in the drawing (which will be referred to as the “first mode” in the present specification).

Referring to the sequence diagram shown in FIG. 2, the power supply circuit 202 is capable of detecting a short circuit that occurs in the output of the power supply circuit 202 in a step in which the bus voltage V_{BUS} of 5 V is generated before the bus switch SW1 is turned on (S102). Accordingly, in this case, the power supply circuit 202 is capable of stopping its operation and of latching the operation state.

However, with the power supply system 100R shown in FIG. 1, the SCP function of the power supply circuit 202 does not enable detection and protection against a short circuit that can occur more toward the load 402 side than the bus switch SW2 as indicated by (ii) in the drawing (which will be referred to as the “second mode” in the present specification).

Description will be made regarding the reason for this. Before the bus switch SW2 is turned on, the path of a short circuit in the second mode has no effect on the system. Accordingly, the operation proceeds up to Step S108 in the sequence diagram shown in FIG. 2.

After the bus switch SW2 on the power receiving apparatus 300R side is turned on, the adapter voltage V_{ADP}, i.e., the power supply voltage for the power receiving apparatus side controller 310, falls in the vicinity of zero, which shuts down the power receiving side controller 310. After the power receiving side controller 310 is shut down, the bus switch SW2 is turned off. Accordingly, the adapter voltage V_{ADP} is restored to a value in the vicinity of the output voltage V_{BUS} of the power supply circuit 202.

That is to say, as viewed from the power supply circuit 202 side, such an arrangement only has an opportunity to detect a short circuit that occurs in the output in a short period of time in which the bus switch SW2 is turned on. However, it is difficult for the SCP function of the power supply circuit 202 to detect a short circuit that occurs in the output in such a short period of time.

It should be noted that such a problem is not restricted to such an arrangement that is compatible with the USB-PD specification. Also, such a problem can occur in power supply systems having a protocol that is similar to that of the USB-PD specification.

### SUMMARY OF THE INVENTION

The present invention has been made in order to solve such a problem. Accordingly, it is an exemplary purpose of an embodiment of the present invention to provide a power supply apparatus that is capable of detecting a short circuit that can occur in a power receiving apparatus.

An embodiment of the present invention relates to a power supply apparatus structured to supply a bus voltage to a power receiving apparatus via a cable. The power supply apparatus comprises: a power supply circuit structured to generate the bus voltage; a bus switch arranged on a path of a bus line extending from an output of the power supply circuit; a power supply side controller structured to be capable of communicating with a power receiving side controller of the power receiving apparatus, to determine a voltage to be supplied based on a negotiation result, and to control the bus switch; and a short circuit detection circuit structured such that, when a predetermined state repeatedly occurs, judgement is made that a short-circuit abnormality has occurred.

When a short circuit has occurred at a position more toward the load side than the bus switch on the power supply circuit side, this leads to a loop having a cycle comprising the bus switch turning on, the power receiving side controller turning off, the bus switch turning on, and negotiation restarting. In this case, the same operation or otherwise the same state repeatedly occurs. Thus, such an arrangement is capable of detecting such a short-circuit abnormality based on whether or not a predetermined state repeatedly occurs in the power supply circuit.

Also, the power supply circuit may comprise an insulation converter and a primary-side controller. Also, the short circuit detection circuit may comprise a first detection circuit built into the primary-side controller. Also, when a state in which a current that flows through a switching transistor of the insulation converter exceeds a predetermined threshold value repeatedly occurs a predetermined number of times, the first detection circuit may judge that a short-circuit abnormality has occurred.

When a short circuit has occurred on the secondary side of the insulation converter, a large current flows through the switching transistor as compared with its steady state. Thus, by detecting whether or not a state in which a large current flows through the switching transistor repeatedly occurs, such an arrangement is capable of detecting a short-circuit abnormality.

Also, the power supply circuit may comprise an insulation converter and a primary-side controller. Also, the short circuit detection circuit may comprise a second detection circuit built into the primary-side controller. Also, when a state in which a power supply voltage for the primary-side controller exceeds a predetermined threshold voltage repeatedly occurs a predetermined number of times, the second detection circuit may judge that a short-circuit abnormality has occurred.

When a short circuit has occurred on the secondary side of the insulation converter, a power supply voltage for the controller, which is generated by means of an auxiliary winding of a transformer, rises. Thus, by detecting whether or not a state in which the power supply voltage for the controller rises repeatedly occurs, such an arrangement is capable of detecting a short-circuit abnormality.

Also, the power supply circuit may comprise an insulation converter and a primary-side controller. Also, the short circuit detection circuit may comprise a third detection circuit built into the primary-side controller. Also, when a state in which a voltage at a feedback terminal of the primary-side controller becomes a high-level voltage repeatedly occurs a predetermined number of times, the third detection circuit judges that a short-circuit abnormality has occurred.

When a short circuit has occurred on the secondary side of the insulation converter, a current that flows through the shunt regulator falls. In this state, the voltage at the feedback terminal becomes the high-level voltage. Thus, by detecting whether or not a state in which the feedback voltage rises repeatedly occurs, such an arrangement is capable of detecting a short-circuit abnormality.

Also, the power supply apparatus according to an embodiment may further comprise a charger circuit structured to switch between an on state and an off state, and to charge the bus line in the on state. Also, the power supply side controller may comprise a fourth detection circuit structured to turn on the charger circuit before the bus switch is turned on, and to judge, based on a voltage at the bus line obtained as a result of this operation, whether or not a short-circuit abnormality has occurred.

Such an arrangement is capable of detecting a short-circuit abnormality that occurs between the bus switch on the power supply apparatus side and the bus switch on the power receiving apparatus side.

Also, the power supply apparatus according to an embodiment may be compatible with the USB-PD specification.

Another embodiment of the present invention relates to an AC adapter. The AC adapter may comprise any one of the aforementioned power supply apparatuses. Yet another embodiment of the present invention relates to an electronic device. The electronic device may comprise any one of the aforementioned power supply apparatuses.

Yet another embodiment of the present invention relates to a primary-side controller for an AC/DC converter of a power supply apparatus. The power supply apparatus comprises: a bus switch arranged on a bus line extending from an output of the AC/DC converter; and a power supply side controller structured to be capable of communicating with a power receiving side controller of a power receiving apparatus, to determine a voltage to be supplied based on a negotiation result, and to control the bus switch. The AC/DC converter comprises: a rectifier circuit; a smoothing capacitor; an insulation converter structured to convert a voltage across the smoothing capacitor; a shunt regulator structured to generate a signal that corresponds to a difference between an output voltage of the insulation converter and a target value thereof; and a photocoupler structured to receive an output of the shunt regulator, and to output a feedback signal. The primary-side controller comprises: a pulse modulator structured to generate a control pulse according to the feedback signal, so as to instruct a switching transistor of the insulation converter to turn on and off; a driver structured to operate the switching transistor according to the control pulse; and a short circuit detection circuit structured such that, when a predetermined state repeatedly occurs in the insulation converter, judgment is made that a short-circuit abnormality has occurred.

Also, the short-circuit detection circuit may comprise a first detection circuit. Also, when a state in which a current that flows through a switching transistor of the insulation converter exceeds a predetermined threshold value repeatedly occurs a predetermined number of times, the first detection circuit may judge that a short-circuit abnormality has occurred.

Also, the short-circuit detection circuit may comprise a second detection circuit. Also, when a state in which a power supply voltage for the primary-side controller exceeds a predetermined threshold voltage repeatedly occurs a predetermined number of times, the second detection circuit may judge that a short-circuit abnormality has occurred.

Also, the short-circuit detection circuit may comprise a third detection circuit. Also, when a state in which a voltage at a feedback terminal of the primary-side controller becomes a high-level voltage repeatedly occurs a predetermined number of times, the third detection circuit may judge that a short-circuit abnormality has occurred.

Also, the primary-side controller may further comprise a charger circuit structured to switch between an on state and an off state, and to charge the bus line in the on state. Also, the power supply side controller may comprise a fourth detection circuit structured to turn on the charger circuit before the bus switch is turned on, and to judge, based on a voltage at the bus line obtained as a result of this operation, whether or not a short-circuit abnormality has occurred.

Also, the primary-side controller may monolithically be integrated on a single semiconductor substrate. Examples of such a “monolithically integrated” arrangement include: an arrangement in which all the circuit components are formed on a semiconductor substrate; and an arrangement in which principal circuit components are monolithically integrated. Also, a part of circuit components such as resistors and capacitors may be arranged in the form of components external to such a semiconductor substrate in order to adjust the circuit constants. By monolithically integrating the circuit on a single chip, such an arrangement allows the circuit area to be reduced, and allows the circuit elements to have uniform characteristics.

It is to be noted that any arbitrary combination or rearrangement of the above-described structural components and so forth is effective as and encompassed by the present embodiments. Moreover, this summary of the invention does not necessarily describe all necessary features so that the invention may also be a sub-combination of these described features.

### BRIEF DESCRIPTION OF THE DRAWINGS

While the preferred embodiments of the present invention have been described using specific terms, such description is for illustrative purposes only, and it is to be understood that changes and variations may be made without departing from the spirit or scope of the appended claims.

Embodiments will now be described, by way of example only, with reference to the accompanying drawings which are meant to be exemplary, not limiting, and wherein like elements are numbered alike in several Figures, in which:

FIG. 1 is a block diagram showing a power supply system investigated by the present inventor;

FIG. 2 is an operation sequence diagram showing the operation of the power supply system shown in FIG. 1;

FIG. 3 is a block diagram showing a power supply system including a power supply apparatus according to an embodiment;

FIG. 4 is an operation waveform diagram showing an operation of the power supply apparatus shown in FIG. 3;

FIG. 5 is an operation waveform diagram showing an operation of the power supply apparatus shown in FIG. 3;

FIG. 6 is a circuit diagram showing an example configuration of the power supply apparatus;

FIG. 7 is a circuit diagram showing a first example configuration of a primary-side controller;

FIG. 8 is a circuit diagram showing a second example configuration of the primary-side controller;

FIG. 9 is a circuit diagram showing a third example configuration of the primary-side controller;

FIG. 10 is a diagram showing a power supply apparatus according to a first modification; and

FIG. 11A is a diagram showing an AC adapter including the power supply apparatus, and FIGS. 11B and 11C are diagrams each showing an electronic device including the power supply apparatus.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, the state represented by the phrase “the member A is coupled to the member B” includes a state in which the member A is indirectly coupled to the member B via another member that does not substantially affect the electric connection therebetween, or that does not damage the functions or effects of the connection therebetween, in addition to a state in which the member A is physically and directly coupled to the member B.

Similarly, the state represented by the phrase “the member C is provided between the member A and the member B” includes a state in which the member A is indirectly coupled to the member C, or the member B is indirectly coupled to the member C via another member that does not substantially affect the electric connection therebetween, or that does not damage the functions or effects of the connection therebetween, in addition to a state in which the member A is directly coupled to the member C, or the member B is directly coupled to the member C.

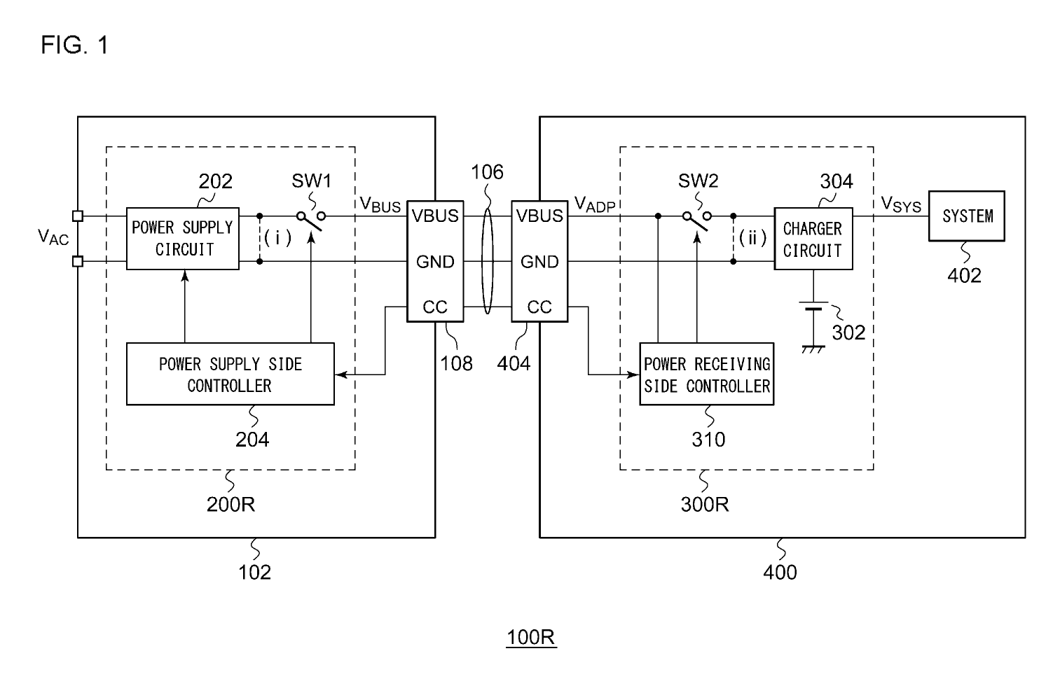

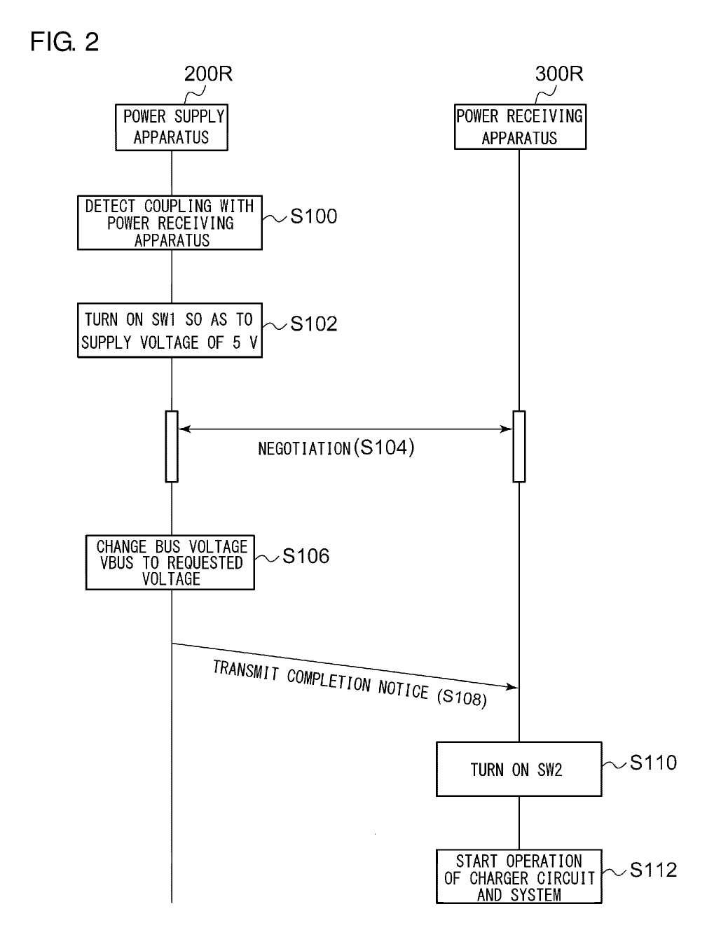

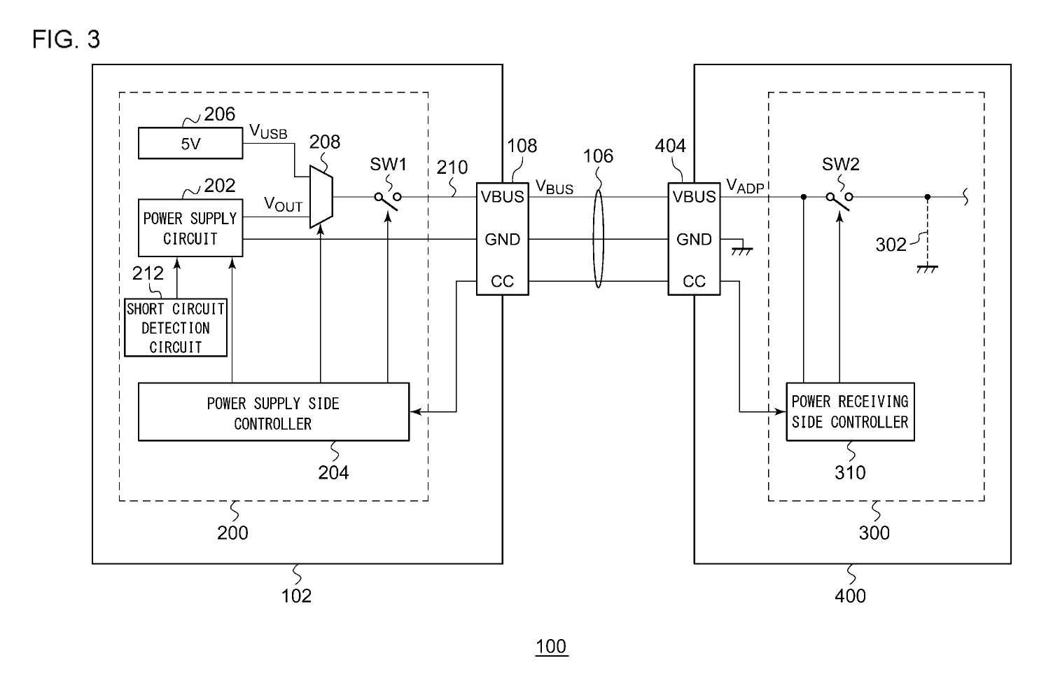

FIG. 3 is a block diagram showing a power supply system 100 including a power supply apparatus 200 according to an embodiment. The power supply system 100 includes a power receiving apparatus 300 and a power supply apparatus 200 that supplies a bus voltage V_{BUS} to the power receiving apparatus 300. The power supply apparatus 200 is built into an adapter 102. The power receiving apparatus 300 is built into an electronic device 400. The electronic device 400 has the same configuration as that shown in FIG. 1. Description will be made assuming that the power supply system 100 according to the present embodiment conforms to the USB-PD specification.

The power supply apparatus 200 includes a power supply circuit 202, a bus switch SW1, a power supply side controller 204, and a 5V power supply 206. The 5V power supply 206 generates a USB voltage V_{USB} of 5 V, which is defined in conventional USB specifications. The power supply circuit 202 generates an output voltage V_{OUT} that is higher than the voltage V_{USB} of 5 V. A selector 208 selects one from among the voltage V_{USB} of 5 V and a voltage V_{OUT} that is higher than the voltage V_{USB}. It should be noted that the 5V power supply 206 and the selector 208 may be monolithically integrated together with the power supply circuit 202. In other words, the power supply circuit 202 may have an additional function for generating the voltage V_{USB} of 5 V. Accordingly, the power supply circuit 202 may be configured as a variable voltage source that is capable of generating a voltage of 5 V and a voltage that is higher than 5 V. The bus switch SW1 is arranged on a path of a bus line 210 that extends from the output of the power supply circuit 202.

The power supply side controller 204 is capable of communicating with a power receiving side controller 310 included in the power receiving apparatus 300. With such an arrangement, the voltage to be supplied is determined, and the states of the power supply circuit 202 and the selector 208 are controlled, by negotiation thus performed between them. Moreover, the power supply side controller 204 controls the bus switch SW1.

The power supply circuit 202 includes a short circuit detection circuit 212 that judges that a short-circuit abnormality has occurred when a predetermined state repeatedly occurs in the power supply circuit 202. For example, the power supply circuit 202 may be configured as an insulated or otherwise non-insulated DC/DC converter.

The above is the configuration of the power supply apparatus 200. Next, description will be made regarding the operation thereof.

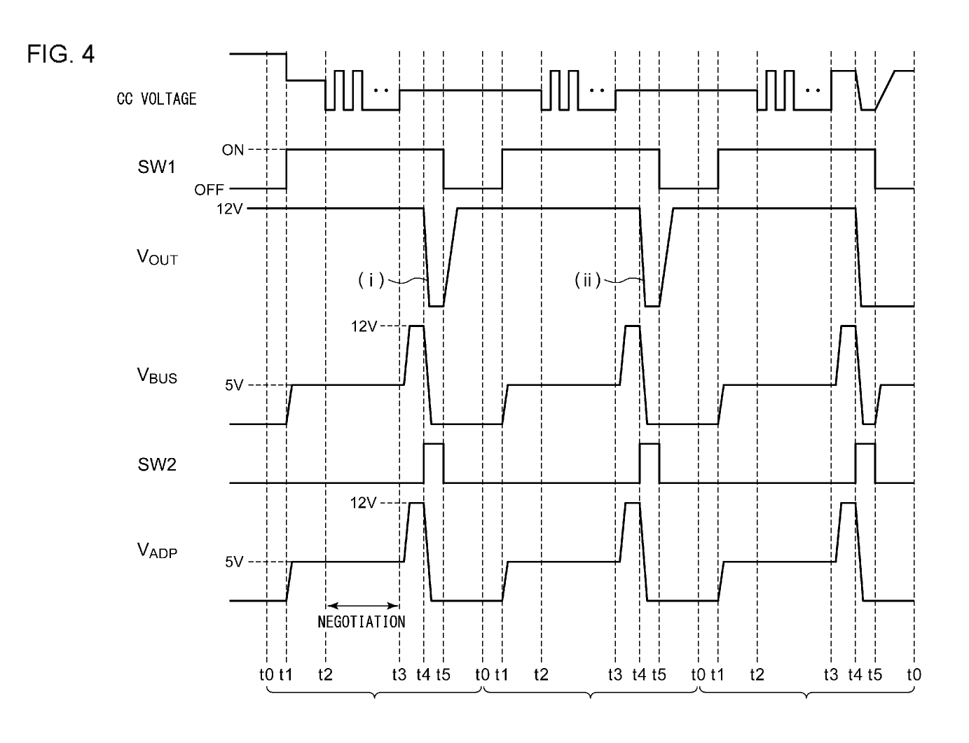

FIG. 4 is an operation waveform diagram showing the operation of the power supply apparatus 200 shown in FIG. 3. Description will be made below assuming that a short circuit 312 has occurred at a position more toward the load side than bus switch SW2 in the power receiving apparatus 300 shown in FIG. 3. Furthermore, description will be made regarding an arrangement in which the power supply side controller 204 receives a power supply voltage from the 5V power supply 206. Accordingly, the operation of the power supply side controller 204 does not stop even if a short circuit has occurred as described later.

When the power supply apparatus 200 and the power receiving apparatus 300 are coupled at the time point to, a voltage is generated at the CC terminal according to a pull-up element of the power supply apparatus 200 side and a pull-down element of the power receiving apparatus 300 side. When the power supply side controller 204 detects the electronic device 400 based on the voltage at the CC terminal, the power supply side controller 204 turns on the bus switch SW1 at the time point t1. The power supply circuit 202 stands by in a state in which an output voltage V_{OUT} of 12 V is generated.

When the bus switch SW1 is turned on, the bus voltage V_{BUS} of 5 V is supplied to the power receiving apparatus 300. In this stage, the adapter voltage V_{ADP} is set to 5 V. When the power receiving side controller 310 enters the operable state based on the adapter voltage V_{ADP} of 5 V, negotiation is started at the time point t2 between the power supply side controller 204 and the power receiving side controller 310. Determination is made based on the negotiation result that the voltage level of the bus voltage V_{BUS} is to be set to a voltage that is higher than 5 V (for example, to 12 V). At the time point t3, the selector 208 selects the output voltage V_{OUT} of the power supply circuit 202. As a result, the bus voltage V_{BUS} is raised, thereby raising the adapter voltage V_{ADP}. Subsequently, when the bus voltage V_{BUS} reaches a target voltage (12 V) at the time point t4, the power supply side controller 204 transmits a signal (PS_RDY message) configured as a notice thereof to the power receiving side controller 310. Upon receiving the notice, the power receiving side controller 310 turns on the bus switch SW2 at the time point t4.

After the bus switch SW2 is turned on, the adapter voltage V_{ADP}, the bus voltage V_{BUS}, and the output voltage V_{OUT} fall to the vicinity of 0 V due to a short circuit 312. When the adapter voltage V_{ADP} falls, this leads to an insufficient power supply for the power receiving side controller 310. In this state, the on state of the bus switch SW2 cannot be maintained. As a result, the bus switch SW2 is turned off at the time point t5.

After the power receiving side controller 310 is shut down, the power supply side controller 204 detects the power receiving side controller 310 again at the time point t0 based on the voltage at the CC terminal. In this case, the power supply side controller 204 turns on the bus switch SW1 again at the time point to.

As described above, if such a short circuit 312 occurs on the power receiving apparatus 300 side, a sequence having a cycle from the time point t0 to the time point t5 is repeatedly performed. Accordingly, directing attention to the power supply circuit 202, the same states occur for every cycle in the power supply circuit 202. Thus, when a cycle of predetermined states repeatedly occurs in the power supply circuit 202, the short circuit detection circuit 212 may detect that a short circuit has occurred on the power receiving apparatus 300 side.

For example, when the short circuit detection circuit 212 detects that a predetermined state has occurred in the power supply circuit 202 a predetermined number of times with predetermined intervals, the short circuit detection circuit 212 may judge that a short-circuit abnormality has occurred. Such predetermined intervals may be determined based on the period of an overall operation that is repeatedly performed in the power supply system 100 when a short circuit has occurred. Also, such predetermined intervals may each have a predetermined extent.

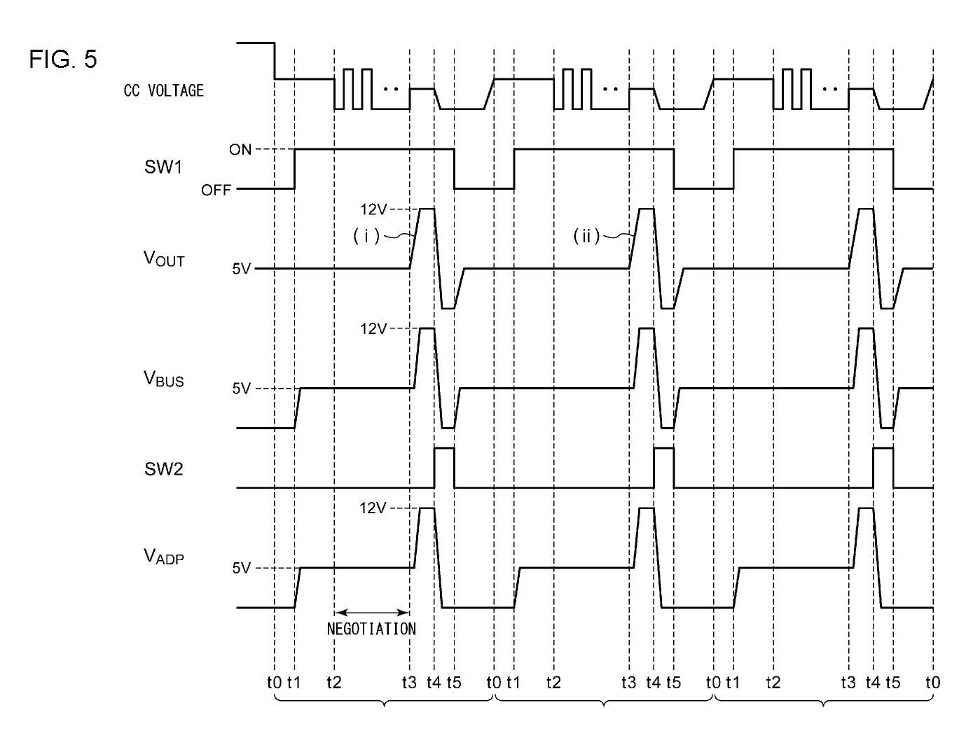

With the power supply apparatus 200 shown in FIG. 3, the 5V power supply 206 and the selector 208 may be omitted, and the power supply circuit 202 may be configured as a variable voltage source that is capable of generating a voltage of 5 V and a voltage (of 12 V or 20 V) that is higher than 5 V. FIG. 5 is an operation waveform diagram showing an operation of the power supply apparatus 200 including the power supply circuit 202 configured as a variable voltage source. Description will be made assuming that a short circuit 312 has occurred at a position more toward the load side than the bus switch SW2 of the power receiving apparatus 300 shown in FIG. 3.

The power supply side controller 204 receives a power supply voltage from the power supply circuit 202. If the output voltage V_{OUT} of the power supply circuit 202 falls, the power supply side controller 204 is shut down.

The power supply apparatus 200 and the power receiving apparatus 300 are coupled at the time point t0. When the power supply side controller 204 detects the electronic device 400 based on the voltage at the CC terminal, the power supply side controller 204 turns on the bus switch SW1 at the time point t1. The power supply circuit 202 stands by in a state in which an output voltage V_{OUT} of 12 V is generated.

When the bus switch SW1 is turned on, the bus voltage V_{BUS} of 5 V is supplied to the power receiving apparatus 300. In this stage, the adapter voltage V_{ADP} is set to 5 V. When the power receiving side controller 310 enters the operable state based on the adapter voltage V_{ADP} of 5 V, negotiation is started between the power supply side controller 204 and the power receiving side controller 310. Determination is made based on the negotiation result that the voltage level of the bus voltage V_{BUS} is to be set to a voltage that is higher than 5 V (for example, 12 V). At the time point t3, the setting voltage for the power supply circuit 202 is changed to 12 V. As a result, the output voltage V_{OUT} is raised to 12 V. Accordingly, the bus voltage V_{BUS} is raised, thereby raising the adapter voltage V_{ADP}. Subsequently, when the bus voltage V_{BUS} reaches a target voltage (12 V) at the time point t4, the power supply side controller 204 transmits a signal (PS_RDY message) configured as a notice thereof to the power receiving side controller 310. Upon receiving the notice, the power receiving side controller 310 turns on the bus switch SW2 at the time point t4.

After the bus switch SW2 is turned on, the adapter voltage V_{ADP}, the bus voltage V_{BUS}, and the output voltage V_{OUT} fall to the vicinity of 0 V due to a short circuit 312. When the adapter voltage V_{ADP} falls, this leads to an insufficient power supply for the power receiving side controller 310. In this state, the on state of the bus switch SW2 cannot be maintained. As a result, the bus switch SW2 is turned off at the time point t5. Furthermore, the output voltage V_{OUT} becomes zero. This means that the power supply for the power supply side controller 204 is lost. Accordingly, the power supply side controller 204 is reset. When the power supply side controller 204 is reset, the pull-up state is released, and accordingly, the voltage at the CC terminal falls to the low level. When the power supply side controller 204 becomes in the operable state after the output voltage V_{OUT} is restored, the pull-up state is reinstated at the CC terminal on the power supply side. Accordingly, a voltage occurs at the CC terminal according to the pull-up element of the power supply apparatus 200 side and the pull-down element of the power receiving apparatus 300 side.

After the power supply side controller 204 and the power receiving side controller 310 are shut down, the power supply side controller 204 detects the power receiving side controller 310 again at the time point t0 based on the voltage at the CC terminal. In this stage, the power supply side controller 204 turns on the bus switch SW1 again at the time point t0.

As described above, if such a short circuit 312 occurs on the power receiving apparatus 300 side, a sequence having a cycle from the time point t0 to the time point t5 is repeatedly performed. Accordingly, directing attention to the power supply circuit 202, the same states occur for every cycle in the power supply circuit 202. Thus, when a cycle of predetermined states repeatedly occurs in the power supply circuit 202, the short circuit detection circuit 212 may detect that a short circuit has occurred on the power receiving apparatus 300 side.

For example, when the short circuit detection circuit 212 detects that a predetermined state has occurred in the power supply circuit 202 a predetermined number of times with predetermined intervals, the short circuit detection circuit 212 may judge that a short-circuit abnormality has occurred. Such predetermined intervals may be determined based on the period of an overall operation that is repeatedly performed in the power supply system 100 when a short circuit has occurred. Also, such predetermined intervals may each have a predetermined extent.

The present invention encompasses various kinds of apparatuses and circuits that can be regarded as a block configuration or a circuit configuration shown in FIG. 3, or otherwise that can be derived from the aforementioned description. That is to say, the present invention is not restricted to a specific circuit configuration. More specific description will be made below regarding an example configuration for clarification and ease of understanding of the essence of the present invention and the circuit operation. That is to say, the following description will by no means be intended to restrict the technical scope of the present invention.

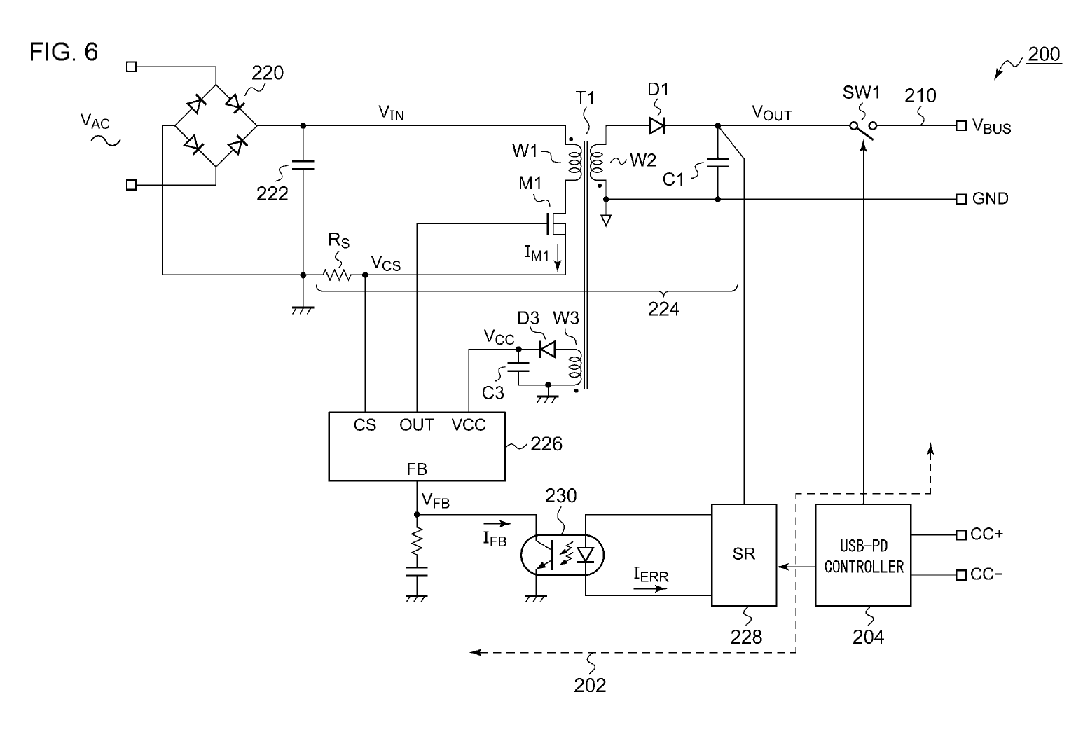

FIG. 6 is a circuit diagram showing an example configuration of the power supply apparatus 200. The power supply circuit 202 is configured as an AC/DC converter. The AC voltage V_{AC} is rectified and smoothed by means of a rectifier circuit 220 and a smoothing capacitor 222, thereby converting the AC voltage V_{AC} into a DC input voltage V_{IN}. An insulation converter 224 steps down the DC input voltage V_{IN}, so as to generate a DC output voltage V_{OUT}. The insulation converter 224 includes a switching transistor M1, a transformer T1, a rectifier element D1, and a capacitor C1.

A primary-side controller 226 stabilizes the output voltage V_{OUT} to a target value together with a shunt regulator 228 and a photocoupler 230. The shunt regulator 228 generates a current I_{ERR} that corresponds to a difference between the output voltage V_{OUT} and its target value V_{REF}. The photocoupler 230 generates a feedback current I_{FB} that corresponds to the current I_{ERR} thus generated on the secondary side. The primary-side controller 226 receives a feedback voltage V_{FB} that corresponds to the feedback current I_{FB}, and drives the switching transistor M1 of the insulation converter 224 with a duty ratio that corresponds to the feedback voltage V_{FB}. A sensing resistor R_{S} is arranged between the source of the switching transistor M1 and the ground. The primary-side controller 226 detects a current I_{M1} that flows through the switching transistor M1, based on a voltage drop (current detection signal) V_{CS} that occurs at the sensing resistor R_{S}.

Upon detecting the coupling with the power receiving apparatus 300, the power supply side controller 204 turns on the bus switch SW1. The power supply side controller 204 controls the shunt regulator 228 based on the negotiation result, so as to change the target value V_{REF} of the output voltage V_{OUT}. Furthermore, when the bus voltage V_{BUS} having a suitable value is generated after the completion of the negotiation, the power supply side controller 204 transmits a notice signal to the power receiving side controller 310 via the CC line.

The transformer T1 of the insulation converter 224 includes an auxiliary winging W3 in addition to a primary winding W1 and a secondary winding W2. The auxiliary winding W3, a diode D3, and a capacitor C3 form an auxiliary converter 232. The auxiliary converter 232 generates a power supply voltage V_{CC} for the primary-side controller 226.

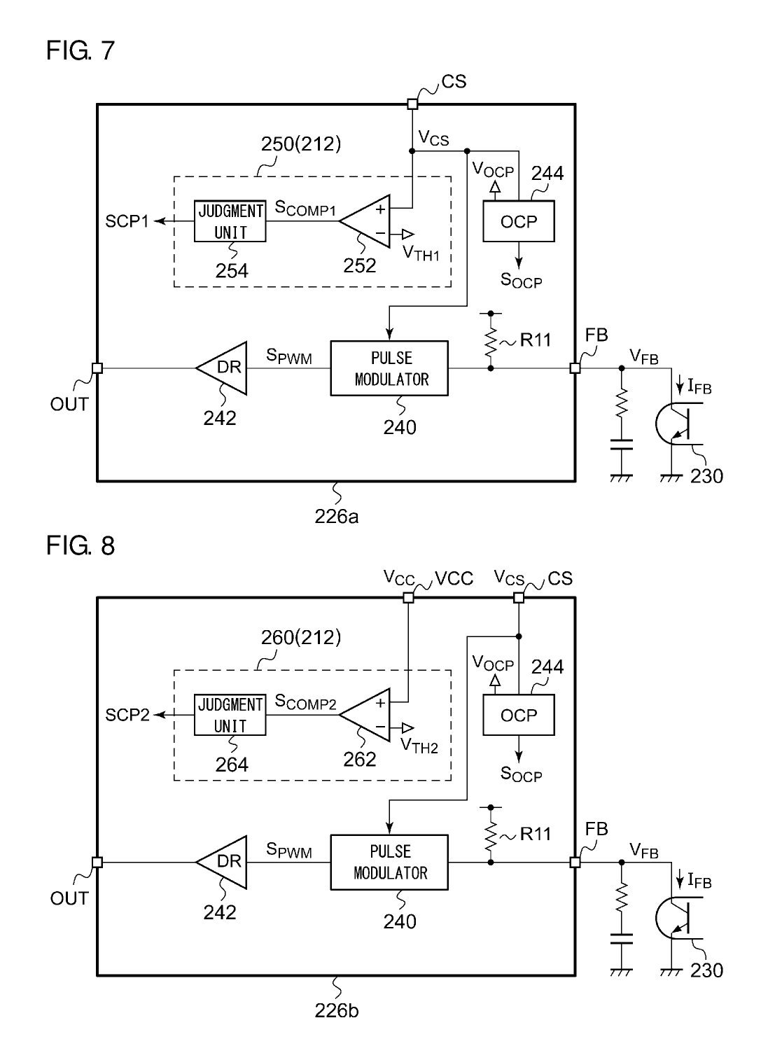

FIG. 7 is a circuit diagram showing a first example configuration (226a) of the primary-side controller 226. The primary-side controller 226a includes a first detection circuit 250 configured as a part of or otherwise all of the components of the short circuit detection circuit 212 shown in FIG. 3, in addition to a pulse modulator (duty controller) 240, a driver 242, and an overcurrent protection (OCP) circuit 244. The pulse modulator 240 generates a pulse signal S_{PWM} having a duty ratio (or otherwise frequency) that corresponds to the feedback voltage V_{FB}. The configuration of the pulse modulator 240 is not restricted in particular. The pulse modulator 240 may be configured as a voltage mode modulator or a current mode modulator. In many cases, a current mode pulse modulator is employed in a converter. Such a current mode pulse modulator 240 includes a feedback loop that stabilizes the current detection signal V_{CS}. The driver 242 drives the switching transistor M1 according to the pulse signal S_{PWM}.

The OCP circuit 244 compares the current detection signal V_{CS} with a threshold value V_{OCP}, so as to detect an overcurrent state. Upon detecting such an overcurrent state, the OCP circuit 244 asserts an OCP signal S_{OCP} (sets to the high level, for example). Immediately after the OCP signal is asserted, the driver 242 turns off the switching transistor M1.

When a state in which the current I_{M1} that flows through the switching transistor M1 of the insulation converter 224 exceeds a predetermined threshold value I_{TH} has been repeatedly detected a predetermined number of times, the first detection circuit 250 judges that a short-circuit abnormality has occurred. Specifically, the first detection circuit 250 includes a comparator 252 and a judgment unit 254. The comparator 252 compares the current detection signal V_{CS} that corresponds to the current I_{M1} with a threshold voltage V_{TH1} that corresponds to the threshold value I_{TH}, and generates a comparison signal S_{COMP1} that indicates a comparison result. When V_{CS}>V_{TH1}, the comparison signal S_{COMP1} is asserted (set to the high level, for example).

When the comparison signal S_{COMP1} is asserted a predetermined number of times with predetermined intervals, the judgment unit 254 asserts (sets to the high level, for example) a short circuit protection signal (SCP1 signal). When the SCP1 signal is asserted, the primary-side controller 226a suspends the driving operation of the switching transistor M1, and latches the operation state of the switching transistor M1. The latched state is maintained until the primary-side controller 226a is reset. Also, the suspension of the switching operation may be automatically released after a predetermined period of time elapses, which is referred to as “automatic restoration protection”. The primary-side controller 226a may notify an external microcomputer or the like of the assertion of the SCP1 signal.

Next, description will be made regarding the operation of the primary-side controller 226a shown in FIG. 7. In the waveform diagram shown in FIG. 4, during a period between t4 and t5 in which the bus switch SW2 is turned on, a short circuit occurs at the output of the insulation converter 224. In this stage, the current I_{ERR} and the feedback current I_{FB} fall to the vicinity of zero. In this case, the feedback voltage V_{FB} is increased, which raises the duty ratio of the switching operation of the switching transistor M1 to a maximum value. This increases the peak value of the current I_{M1} that flows through the switching transistor M1. Eventually, the peak value of the current I_{M1} exceeds the threshold value I_{TH}, and the comparison signal S_{COMP1} is asserted. Such assertion of the comparison signal S_{COMP1} occurs for every cycle shown in FIG. 4. Accordingly, a short circuit can be detected based on a detection result in which assertion of the comparison signal S_{COMP1} has been repeatedly detected.

It should be noted that the threshold current I_{TH} may be set to the same value as the threshold value designed for the overcurrent protection. In this case, the comparator 252 of the first detection circuit 250 and an internal comparator included in the OCP circuit 244 may be configured as a single shared comparator.

FIG. 8 is a circuit diagram showing a second example configuration (226b) of the primary-side controller 226. The primary-side controller 226b includes a second detection circuit 260 configured as a part of or otherwise all of the components of the short circuit detection circuit 212 shown in FIG. 3.

When the second detection circuit 260 repeatedly detects a state in which the power supply voltage V_{CC} for the primary-side controller 226b exceeds a predetermined threshold voltage V_{TH2} a predetermined number of times, the second detection circuit 260 judges that a short-circuit abnormality has occurred. The second detection circuit 260 may have the same configuration as that of the first detection circuit 250 shown in FIG. 7. The second detection circuit 260 includes a comparator 262 and a judgment unit 264. The comparator 262 compares the power supply voltage V_{CC} or otherwise a voltage detection signal that corresponds to the power supply voltage V_{CC} with the threshold value V_{TH2}, and generates a comparison signal S_{COMP2} that indicates the comparison result. When V_{CC}>V_{TH2}, the comparison signal S_{COMP2} is asserted (set to the high level, for example).

When the comparison signal S_{COMP2} is asserted a predetermined number of times with predetermined intervals, the judgment unit 264 asserts (sets to the high level, for example) a short circuit protection signal (SCP2 signal). When the SCP2 signal is asserted, the primary-side controller 226b suspends the driving operation of the switching transistor M1, and latches the operation state of the switching transistor M1.

Next, description will be made regarding the operation of the primary-side controller 226b shown in FIG. 8. In the waveform diagram shown in FIG. 4, during a period between the time points t4 and t5 in which the bus switch SW2 is turned on, a short circuit occurs at the output of the insulation converter 224. In this case, the current I_{ERR} and the feedback current I_{FB} each fall to the vicinity of zero. This leads to an increase in the feedback voltage V_{FB}, which raises the duty ratio of the switching operation of the switching transistor M1 to a maximum value. In this case, the current supplied to the capacitor C3 from the auxiliary winding W3 becomes excessively large, leading to an increase in the power supply voltage V_{CC}, and the comparison signal S_{COMP2} is asserted. Such assertion of the comparison signal S_{COMP2} occurs for every cycle in FIG. 4. Accordingly, a short circuit may be detected based on a state in which assertion of the comparison signal S_{COMP2} has been repeatedly detected.

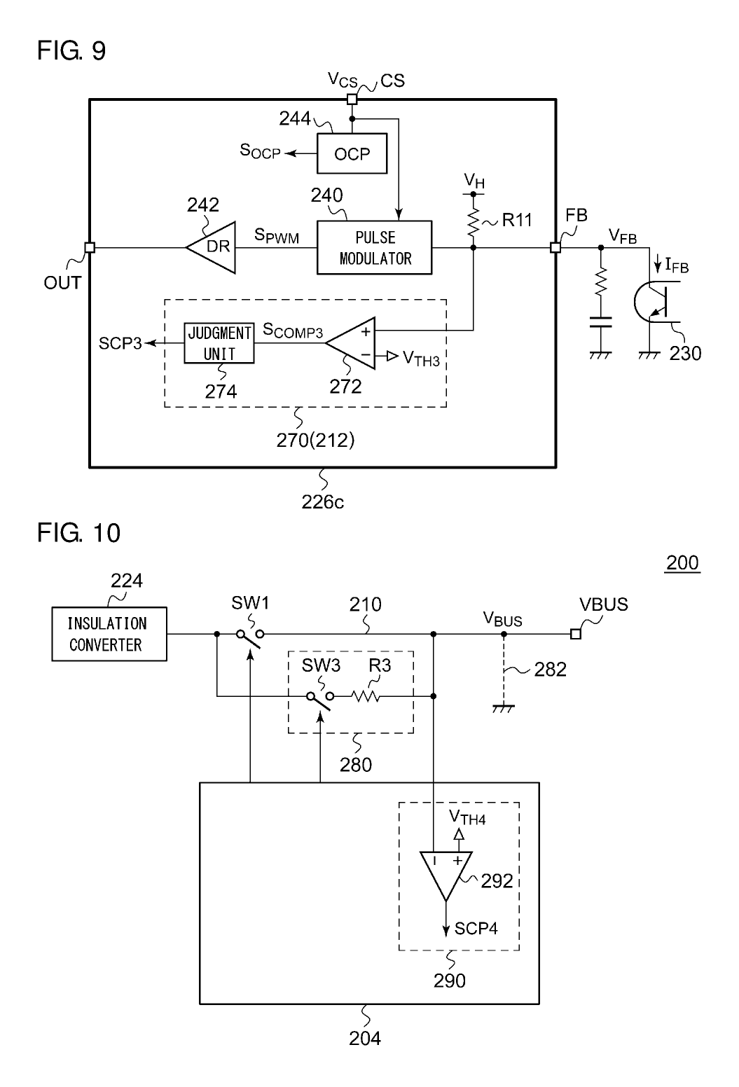

FIG. 9 is a circuit diagram showing a third example configuration (226c) of the primary-side controller 226. The primary-side controller 226c includes a third detection circuit 270 configured as a part of or otherwise all of the components of the short circuit detection circuit 212 shown in FIG. 3.

When a state in which the voltage V_{FB} at the feedback (FB) terminal of the primary-side controller 226c becomes the high-level voltage is repeatedly detected a predetermined number of times, the third detection circuit 270 judges that a short-circuit abnormality has occurred. The third detection circuit 270 may have the same configuration as that of the first detection circuit 250 shown in FIG. 7 or that of the second detection circuit 260 shown in FIG. 8. Specifically, the third detection circuit 270 includes a comparator 272 and a judgement unit 274. The comparator 272 compares the feedback voltage V_{FB} or otherwise a voltage detection signal that corresponds to the feedback voltage V_{FB} with a threshold value V_{TH3}, and generates a comparison signal S_{COMP3} that indicates the comparison result. When V_{FB}>V_{TH3}, the comparison signal S_{COMP3} is asserted (set to the high level, for example).

When assertion of the comparison signal S_{COMP3} occurs a predetermined number of times with predetermined intervals, the judgment unit 274 asserts (sets to the high level, for example) a short circuit protection signal (SCP3 signal). When the SCP3 signal is asserted, the primary-side controller 226c suspends the driving operation of the switching transistor M1, and latches the operation state of the switching transistor M1.

Next, description will be made regarding the operation of the primary-side controller 226c shown in FIG. 9. In the waveform diagram shown in FIG. 4, during a period between the time points t4 and t5 in which the bus switch SW2 is turned on, a short circuit occurs at the output of the insulation converter 224. In this case, the current I_{ERR} and the feedback current I_{FB} each fall to the vicinity of zero. In this state, the FB terminal is pulled up to the high-level voltage V_{H} via the resistor R11, and accordingly, the voltage at the FB terminal becomes larger than the threshold voltage V_{TH3}, and the comparison signal S_{COMP3} is asserted. Such assertion of the comparison signal S_{COMP3} occurs for every cycle in FIG. 4. Accordingly, a short circuit may be detected based on a state in which assertion of the comparison signal S_{COMP3} has repeatedly occurred.

Description has been made above regarding the present invention with reference to the embodiment. The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding such modifications.

### First Modification

FIG. 10 is a diagram showing a power supply apparatus 200a according to a first modification. The power supply apparatus 200a further comprises a charger circuit 280. The charger circuit 280 is configured to be switchable between the on state and the off state. In the on state, the charger circuit 280 charges the bus line 210. For example, the bus line 210 includes a switch SW3 and a resistor R3 arranged in parallel with the bus switch SW1. The on state of the switch SW3 corresponds to the on state of the charger circuit 280. The charger circuit 280 may be configured as a current source that is switchable between the on state and the off state.

A power supply side controller 204a includes a fourth detection circuit 290. The power supply side controller 204a turns on the charger circuit 280 before the bus switch SW1 is turned on. The fourth detection circuit 290 judges the presence or absence of a short-circuit abnormality based on the voltage V_{BUS} at the bus line 210 obtained as a result of this operation. When such an abnormality has been detected, the fourth detection circuit 290 asserts (sets to the high level, for example) an SCP4 signal. The fourth detection circuit 290 may include a comparator 292 that compares the bus voltage V_{BUS} with a threshold voltage V_{TH4}.

In a case in which such a short circuit 282 has not occurred at the bus line 210 (or at the USB cable 106), after the charger circuit 280 is turned on, the bus voltage V_{BUS} rises with time. Eventually, the bus voltage V_{BUS} exceeds the threshold voltage V_{TH4}. If such a short circuit 282 has occurred, the bus voltage V_{BUS} does not rise. Accordingly, the bus voltage V_{BUS} remains lower than the threshold voltage V_{TH4}.

As described above, by providing such a fourth detection circuit 290, such an arrangement is capable of detecting a short-circuit abnormality that can occur between the bus switch SW1 and the bus switch SW2.

### Second Modification

Description has been made in the embodiment regarding an arrangement in which a short circuit is detected based on any one of: (i) repeated detection of an increase in the current I_{M1} that flows through the switching transistor M1; (ii) repeated detection of an increase in the power supply voltage V_{CC} for the power supply side controller 204; and (iii) repeated detection of an increase in the voltage V_{FB} at the FB terminal of the power supply side controller 204. However, the present invention is not restricted to such an arrangement. For example, a desired combination of two or more circuits from among the first detection circuit 250, the second detection circuit 260, and the third detection circuit 270, shown in FIGS. 7 through 9, may be built into the power supply side controller 204. In this case, the judgment units 254, 264, and 274 may be configured as a single shared judgment unit.

### Third Modification

Also, examples of such a predetermined state of the power supply circuit 202 to be used for a short circuit detection condition may include a state in which the power supply circuit 202 is started up, and a state in which the operation of the power supply circuit 202 is stopped, in addition to the states (i) through (iii) described above. Also, in a case in which the power supply circuit 202 is configured as a variable power supply that is capable of generating a voltage of 5 V and a voltage (e.g., 12 V or 25 V) that is higher than 5 V, a short circuit may be detected based on a state in which the output voltage switching is repeatedly performed.

### Fourth Modification

Description has been made in the embodiment regarding the power supply apparatus 200 that is compatible with the USB-PD specification. However, the present invention is not restricted to such an arrangement. Rather, the present invention is applicable to other specifications having features similar to those of the USB-PD specification that will be developed in the future.

### [Usage]

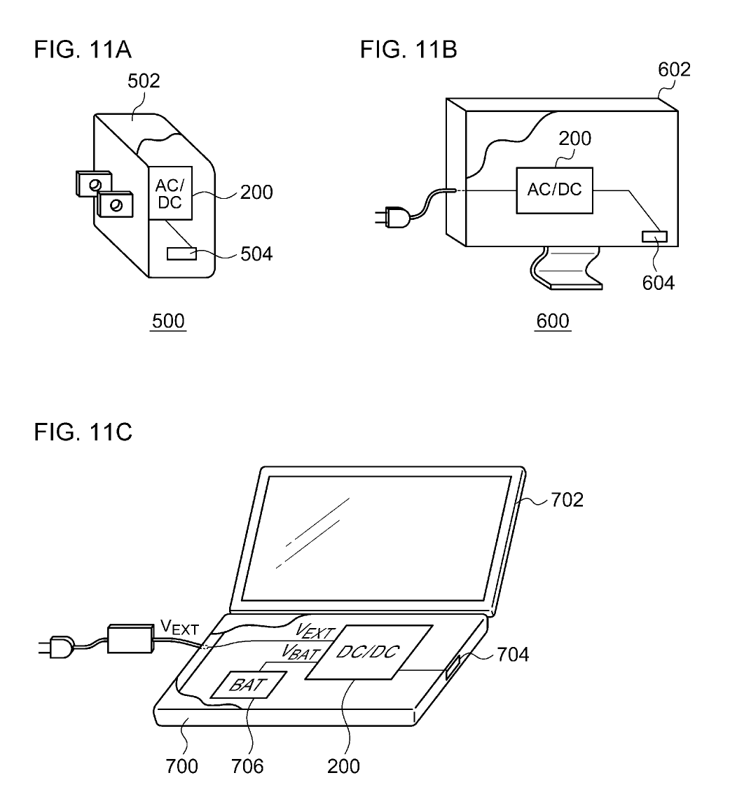

Lastly, description will be made regarding the usage of the power supply apparatus 200. FIG. 11A is a perspective view of an AC adapter 500 including the power supply apparatus 200. The AC adapter 500 includes a housing 502, a receptacle 504, and the power supply apparatus 200. The power supply circuit 202 of the power supply apparatus 200 is configured as an AC/DC converter.

FIG. 11B is a perspective view of an electronic device 600 including the power supply apparatus 200. The electronic device 600 is configured as a device including no built-in battery, as with display apparatuses. The electronic device 600 includes a housing 602, a receptacle 604, and the power supply apparatus 200. The power supply circuit 202 of the power supply apparatus 200 is configured as an AC/DC converter.

FIG. 11C is a perspective view of an electronic device 700 including the power supply apparatus 200. The electronic device 700 is configured as a device including a built-in battery, as with laptop PCs or tablet PCs. The electronic device 700 includes a housing 702, a receptacle 704, a battery 706, and the power supply apparatus 200. The power supply circuit 202 of the power supply apparatus 200 is configured as a DC/DC converter that receives a DC voltage V_{BAT} from the battery 706 or otherwise a DC voltage V_{EXT} from an external AC adapter 720, and that generates the bus voltage V_{BUS}.

As described above, the power supply apparatus 200 can be mounted on various kinds of electronic devices and AC adapters.

While the preferred embodiments of the present invention have been described using specific terms, such description is for illustrative purposes only, and it is to be understood that changes and variations may be made without departing from the spirit or scope of the appended claims.

What is claimed is:

1. A power supply apparatus structured to supply a bus voltage to a power receiving apparatus via a cable, the power supply apparatus comprising:
a power supply circuit structured to generate the bus voltage;
a bus switch arranged on a path of a bus line extending from an output of the power supply circuit;
a power supply side controller structured to communicate with a power receiving side controller of the power receiving apparatus, to determine a voltage to be supplied based on a negotiation result, and to control the bus switch; and
a short circuit detection circuit structured such that, when a predetermined state repeatedly occurs, judgement is made that a short-circuit abnormality has occurred.

2. The power supply apparatus according to claim 1, wherein the power supply circuit comprises an insulation converter and a primary-side controller,
wherein the short circuit detection circuit comprises a first detection circuit built into the primary-side controller,
and wherein, when a state in which a current that flows through a switching transistor of the insulation converter exceeds a predetermined threshold value repeatedly occurs a predetermined number of times, the first detection circuit judges that a short-circuit abnormality has occurred.

3. The power supply apparatus according to claim 1, wherein the power supply circuit comprises an insulation converter and a primary-side controller,
wherein the short circuit detection circuit comprises a second detection circuit built into the primary-side controller,
and wherein, when a state in which a power supply voltage for the primary-side controller exceeds a predetermined threshold voltage repeatedly occurs a predetermined number of times, the second detection circuit judges that a short-circuit abnormality has occurred.

4. The power supply apparatus according to claim 1, wherein the power supply circuit comprises an insulation converter and a primary-side controller,
wherein the short circuit detection circuit comprises a third detection circuit built into the primary-side controller,
and wherein, when a state in which a voltage at a feedback terminal of the primary-side controller becomes a high-level voltage repeatedly occurs a predetermined number of times, the third detection circuit judges that a short-circuit abnormality has occurred.

5. The power supply apparatus according to claim 1, further comprising a charger circuit structured to switch between an on state and an off state, and to charge the bus line in the on state,
and wherein the power supply side controller comprises a fourth detection circuit structured to turn on the charger circuit before the bus switch is turned on, and to judge, based on a voltage at the bus line obtained as a result of this operation, whether or not a short-circuit abnormality has occurred.

6. The power supply apparatus according to claim 1, which is compatible with the USB-PD specification.

7. An AC adapter comprising the power supply apparatus according to claim 1.

8. An electronic device comprising the power supply apparatus according to claim 1.

9. A primary-side controller for an AC/DC converter of a power supply apparatus, wherein the power supply apparatus comprises:
a bus switch arranged on a bus line extending from an output of the AC/DC converter; and
a power supply side controller structured to communicate with a power receiving side controller of a power receiving apparatus, to determine a voltage to be supplied based on a negotiation result, and to control the bus switch,
wherein the AC/DC converter comprises:
a rectifier circuit;
a smoothing capacitor;
an insulation converter structured to convert a voltage across the smoothing capacitor;
a shunt regulator structured to generate a signal that corresponds to a difference between an output voltage of the insulation converter and a target value thereof; and
a photocoupler structured to receive an output of the shunt regulator, and to output a feedback signal,
and wherein the primary-side controller comprises:
a pulse modulator structured to generate a control pulse according to the feedback signal, so as to instruct a switching transistor of the insulation converter to turn on and off;
a driver structured to operate the switching transistor according to the control pulse; and
a short circuit detection circuit structured such that, when a predetermined state repeatedly occurs in the insulation converter, judgment is made that a short-circuit abnormality has occurred.

10. The primary-side controller according to claim 9, wherein the short-circuit detection circuit comprises a first detection circuit,
and wherein, when a state in which a current that flows through a switching transistor of the insulation converter exceeds a predetermined threshold value repeatedly occurs a predetermined number of times, the first detection circuit judges that a short-circuit abnormality has occurred.

11. The primary-side controller according to claim 9, wherein the short-circuit detection circuit comprises a second detection circuit,
and wherein, when a state in which a power supply voltage for the primary-side controller exceeds a predetermined threshold voltage repeatedly occurs a predetermined number of times, the second detection circuit judges that a short-circuit abnormality has occurred.

12. The primary-side controller according to claim 9, wherein the short-circuit detection circuit comprises a third detection circuit,
and wherein, when a state in which a voltage at a feedback terminal of the primary-side controller becomes a high-level voltage repeatedly occurs a predetermined number of times, the third detection circuit judges that a short-circuit abnormality has occurred.

13. The primary-side controller according to claim 9, further comprising a charger circuit structured to switch between an on state and an off state, and to charge the bus line in the on state,
and wherein the power supply side controller comprises a fourth detection circuit structured to turn on the charger circuit before the bus switch is turned on, and to judge, based on a voltage at the bus line obtained as a result of this operation, whether or not a short-circuit abnormality has occurred.

14. The primary-side controller according to claim 9, which is compatible with the USB-PD standard.

15. The primary-side controller according to claim 9, monolithically integrated on a single semiconductor substrate.

16. A short circuit detection method employed in a power supply apparatus that is compatible with the USB-PD standard, wherein the power supply apparatus comprises a power supply circuit,
and wherein the short circuit detection method comprises:
asserting a detection signal when the state of the power supply circuit becomes a predetermined state; and
judging that a short-circuit abnormality has occurred when assertion of the detection signal repeatedly occurs.

17. The short circuit detection method according to claim 16, wherein the power supply circuit comprises an insulation converter,
and wherein the predetermined state includes a state in which a current that flows through a switching transistor of the insulation converter exceeds a predetermined threshold value.

18. The short circuit detection method according to claim 16, wherein the power supply circuit comprises an insulation converter,
and wherein the predetermined state includes a state in which a power supply voltage for a primary-side controller of the insulation converter exceeds a predetermined threshold voltage.

19. The short circuit detection method according to claim 16, wherein the power supply circuit comprises an insulation converter,
and wherein the predetermined state includes a state in which a voltage at a feedback terminal of a primary-side controller of the insulation converter becomes a high-level voltage.
